(19) United States
(12) Patent Application Publication
(10) Pub. No.: US 2025/0358013 A1
(43) Pub. Date: Nov. 20, 2025

(54) INFORMATION EXCHANGE USING AN EVENT CAMERA

(71) Applicant: Inivation AG, Zürich (CH)

(72) Inventors: Pierre GIRAUD, Zürich (CH); Adam RADOMSKI, Zürich (CH)

(73) Assignee: Inivation AG, Zürich (CH)

(21) Appl. No.: 18/871,965

(22) PCT Filed: Jun. 5, 2023
(86) PCT No.: PCT/IB2023/055773

§ 371 Date: Dec. 5, 2024

(30) Foreign Application Priority Data
Jun. 8, 2022 (EP) 22177812.9

(51) Int. Cl. H04B 10/516; H04B 10/60; H04N 7/22; H04N 25/47

(52) U.S. Cl. CPC H04B 10/516; H04B 10/60; H04N 7/22; H04N 25/47

(57) ABSTRACT

A method for transmitting a binary data sequence having at least two binary values from an information source to an information destination. The method includes the following steps: 1) determining a line code representation based on the binary data sequence, wherein the line code representation is such that a clock used for determining the line code representation based on the binary data sequence is recoverable from the line code representation, 2) optically transmitting the line code representation using a light source by modulating emitted light intensity of the light source based on the line code representation, 3) capturing the optically transmitted line code representation using an event camera, wherein the event camera is configured to generate events based on intensity changes in the captured optically transmitted line code representation, and 4) determining a recovered binary data sequence based on the generated events, wherein the determining of the recovered binary data sequence includes recovering the clock based on the generated events and measuring at least one time difference between generated events using the recovered clock. An assembly and a computer implemented method are also provided.

### FIELD OF THE INVENTION

The present invention relates to a method for transmitting a binary data sequence comprising at least two binary values from an information source to an information destination. The present invention further relates to an assembly comprising an information source, a light source, an event camera and an information destination, and to a computer program product.

### BACKGROUND TO THE INVENTION

Event cameras such as the dynamic vision sensor (DVS) are known in the fields of robotics and autonomous driving, for example. Contrary to classical camera sensors, event camera sensors only provide an output in case something changes in the scene which they are observing. Said differently, if no changes occur, the event camera provides no output, while a classical camera would still (periodically) sample the unchanging scene it observes. An event camera may therefore provide a sparse output with low latency and high dynamic range as event cameras often operate on a logarithm of incoming light intensity. Furthermore, as each pixel in an event camera is typically independent of other pixels, only those pixels of the event camera at which changes occur would generate events, thereby making the output of an event camera even sparser. Event cameras may be therefore suited for high-speed control applications or for surveying applications, for example, as they would only react once changes happen. A potential drawback of event cameras is that during times of rapid changes such as background illumination changes due to changing illumination conditions, a large number of events may be generated; in some cases, event cameras may therefore generate larger amounts of data than classical camera sensors.

In control/surveying applications in which classic camera sensors are used, a large amount of computing power often needs to be spent to process images, often involving wasted computation during times of no/insignificant changes to the observed scene.

In more abstract terms, an information source may want to transmit some information to an information destination. A possible information source is, e.g., a traffic light control software operating a traffic light, and an information destination is, e.g., an algorithm used as part of an autonomous driving software which decides whether a car should accelerate. In case a conventional camera installed in a car monitors a traffic light, most of the captured data may be irrelevant for the specific task at hand and therefore wasted.

It is an object of the present invention to mitigate at least some of the disadvantages associated with information transmission between an information source and an information destination. In particular, the present invention provides a fast and robust information transmission between the information source and the information destination.

### SUMMARY OF THE INVENTION

According to a first aspect of the present invention there is provided a method for transmitting a binary data sequence comprising at least two binary values from an information source to an information destination, involving the steps recited in claim 1. Further features and embodiment of the method of the present invention are described in the dependent patent claims.

The invention relates to a method for transmitting a binary data sequence comprising at least two binary values from an information source to an information destination. The method comprises the following steps: 1) determining a line code representation based on the binary data sequence, wherein the line code representation is such that a clock used for determining the line code representation based on the binary data sequence is recoverable from the line code representation, 2) optically transmitting the line code representation using a light source by modulating emitted light intensity of the light source based on the line code representation, 3) capturing the optically transmitted line code representation using an event camera, wherein the event camera is configured to generate events based on intensity changes in the captured optically transmitted line code representation, and 4) determining a recovered binary data sequence based on the generated events, wherein the determining of the recovered binary data sequence comprises recovering the clock based on the generated events and measuring at least one time difference between generated events using the recovered clock.

The term binary data sequence may refer to all temporally discretized and quantized data sequences which may be converted without loss of information to a binary data sequence comprising ‘1’ and ‘0’ entries. The term line code representation may refer to a representation which may be transmitted over a physical channel, in particular an optical channel: as such, the term line code representation may refer to a representation which is quantized in amplitude but continuous in time, for example. The line code representation may be adapted to the physical channel over which it is transmitted. In noisy channels, for example, line code representations comprising fine amplitude quantization may be less robust to noise than line code representations comprising coarse amplitude quantization. The line code representation may furthermore be adapted to the available bandwidth of the physical channel: in case of limited bandwidth, for example, information in the line code representation may not be encoded in too steep flanks of the line code representation.

The information source and the information destination may not be actively synchronized with one another. The line code representation used is such that based on the line code representation, the clock used for encoding the binary data sequence (or a processed form of the binary data sequence) into the line code representation is faithfully recoverable even in case of longer intervals during which a same binary value is transmitted over the physical channel. By observing the line code representation (respectively a suitably sampled version of the line code representation), the information destination may synchronize its own clock to the clock of the information source, e.g., using a phase-locked loop, and thereby measure time in a similar way as done by the information source.

The line code representation is transmitted over an optical channel, e.g., embodied as air or as a dedicated cable. The line code representation may be transmitted by a flashing LED, for example. In case the line code representation comprises only two possible magnitude values, for example, the LED may be turned on for one of the two possible magnitude values and turned off for the other of the two possible magnitude values. The information present in the original binary data sequence may therefore be temporally encoded into a succession of LED flashes.

The transmitted line code representation is captured by an event camera. An event camera may comprise a matrix of pixels which act independently of one another. Each pixel typically produces an event in case an observed intensity of light impinging on its photosensitive area changes: events may represent increasing and/or decreasing intensity. Besides the desired optically transmitted line code representation impinging on the event camera, background light changes or other light sources may also lead to events which are generated by the event camera. It may be therefore assumed that the information destination knows which encoding method the information source is using to derive the line code representation from the binary data sequence: this way, suitable (frequency) filtering may be implemented by the information destination to separate events corresponding to the desired optically transmitted line code representation from in general undesired events caused by other light changes. The events corresponding to the line code representation are used by the information destination to synchronize its clock to the clock of the information source. In case the line code representation is, for example, such that the binary data sequence is encoded in periodically spaced rising or falling flanks, rising or falling events will typically also be generated by the event camera. The clock of the information destination may be synchronized to such periodically occurring events. Subsequently, a binary data sequence may be recovered by the information destination. For this purpose, at least one time difference between events may be determined; the at least one time difference may be determined between events of opposite polarity (corresponding to rising or falling intensity).

In an embodiment of the method according to the invention, the binary data sequence is modified using an error correction code prior to determining the line code representation based on the binary data sequence.

To allow the information destination to at least partly remove potential errors in the recovered binary data sequence and thereby bring the recovered binary data sequence closer to the binary data sequence, the information source may apply error correction techniques to the binary data sequence prior to determining a line code representation. A possible error correction technique are checksums, for example. Other error correction techniques are, however, also possible.

In a further embodiment of the method according to the invention, the determined line code representation based on the binary data sequence is a Manchester code representation.

In a Manchester code, information is encoded in the flanks of the line code representation lying in the middle of the underlying clock period. The information destination may therefore recover the binary data sequence based on (polarized—i.e., measuring increasing resp. decreasing intensity) events at these periodically spaced times in the middle of the underlying clock periods.

In a further embodiment of the method according to the invention, the determined line code representation based on the binary data sequence maps at least one group of binary values of the binary data sequence onto a respective at least one group of transmission binary values.

Besides Manchester coding or modifications thereof, more general line coding schemes may be used which map, e.g., m data bits of the binary data sequence onto n line bits which are then used to, e.g., define control signals for a light source optically transmitting the line code representation.

In a further embodiment of the method according to the invention, a prefix binary data sequence is prepended to the binary data sequence.

To inform the information destination that data transmission is about to start, the information source may prepend a prefix binary data sequence to the binary data sequence. In case the prefix binary data sequence is also known to the information destination, such a prefix binary data sequence may allow the information destination to know when actual data transmission commences.

In a further embodiment of the method according to the invention, the line code representation comprises at least one fundamental frequency at which information related to the binary data sequence is transmitted, and the determining of the recovered binary data sequence comprises frequency filtering the generated events to determine events temporally separated from one another at at least one fundamental period corresponding to the at least one fundamental frequency.

In case information is transmitted at periodic time points (e.g., in the middle of underlying clock periods in case of Manchester coding), the respective at least one fundamental period corresponds to at least one fundamental frequency. To separate such periodically occurring events from spurious events caused by background light changes, for example, frequency filtering may be performed. Frequency filtering may proceed as follows: the information destination may know a fundamental frequency f at which information is transmitted by the information source; the information destination may set up a Gaussian distribution centered at a corresponding fundamental period with a variance determined by known properties of the used specific event camera. The probability of time differences between generated events based on the set-up Gaussian distribution may be evaluated, and thereby the likelihood may be determined that a specific pair of events corresponds to the information transmitted by the information source.

In a further embodiment of the method according to the invention, the binary data sequence is an identifier sequence encoding identity information about the information source.

The detected identifier sequence may influence behavior of the information destination, e.g., in an authentication application. The information destination may also commence with further processing, i.e., “wake up”, after detection of an identifier sequence.

In a further embodiment of the method according to the invention, a second binary data sequence is transmitted from the information source to the information destination at least partly in parallel to the transmitting of the binary data sequence.

The information source may also transmit a second binary data sequence, which second binary data sequence is independent of the binary data sequence, to the information destination while also transmitting the binary data sequence. The information source may also transmit further independent binary data sequences to the information destination. The second (and potentially further) binary data sequence(s) may be transmitted to the information destination by similar means as the binary data sequence.

In a further embodiment of the method according to the invention, a second line code representation based on the binary data sequence is determined, wherein the second line code representation is such that a second clock used for determining the second line code representation based on the second binary data sequence is recoverable from the second line code representation, and the second line code representation is optically transmitted using the light source or using a second light source, and the optically transmitted second line code representation is captured by the event camera.

For transmitting the second line code representation, a second light source distinct from the light source used for transmitting the line code representation may be used. The second light source may be physically separated from the light source. For a separate second light source, events generated by the event camera may be clustered into a group corresponding to the light source and into a group corresponding to the second light source based on spatial criteria or on temporal criteria. In case the light source can independently emit at multiple wavelengths, for example, one and the same light source may be used for emitting both the line code representation and the second line code representation, e.g., at different wavelengths. Using color filters on the event camera (e.g., embodied in the form of a Bayer pattern), the line code representation and the second line code representation may be separated. In case multiple light sources are available, the information source may also transmit information to the information destination using spatial encoding: depending on which of the light sources is—at a given moment in time—on or off, different data may be transmitted to the information destination. The second clock may be the same clock as the clock used for encoding the binary data sequence into the line code representation. Alternatively, it may be a different clock, or it may be a derived clock from the clock for encoding the binary data sequence.

In a further embodiment of the method according to the invention, the second line code representation comprises at least one second fundamental frequency which at least partly differs from the at least one fundamental frequency.

The information in the second binary data sequence may therefore be transmitted at different rates compared to the information transmitted in the binary data sequence. Such knowledge may be used by the information destination to separate events corresponding to the binary data sequence from events corresponding to the second binary data sequence.

According to a further aspect of the present invention there is provided an assembly comprising an information source, a light source, an event camera and an information destination, wherein the assembly is configured to carry out a method according to the invention.

Information source and light source may be embodied as distinct physical entities or may be provided as one physical object. The information source may also correspond to software running on an information source computing device, and the information destination may also correspond to software running on a computing device. Alternatively, information source and/or information destination may be embodied as dedicated hardware, e.g., in the form of an application-specific integrated circuit or as a field-programmable gate array. Besides the optical transmission of the line code representation (or additional line code representations such as the second line code representations), no further information exchange between the information source and the information destination may need to take place.

In an embodiment of the assembly according to the invention, the information destination is embodied as a computing device, in particular as a microprocessor, and the information source is embodied as one of: 1) a traffic light control unit, or 2) a car lighting control unit, or 3) an active marker control unit for robot tracking, or 4) a docking station control unit for space application and/or logistics applications and/or robotics applications, or 5) an aircraft and/or drone landing control unit, or 6) a calibration system for surveying, in particular using a total station, or 7) wearable or portable devices attached to humans or animals.

The method according to the invention may, however, also be applied to other use cases/applications. As logistic application, robot localization in warehouses may use the method according to the invention Instead of using QR codes at known locations in the warehouse.

In a further embodiment of the assembly according to the invention, the light source is embodied as a light-emitting diode (LED), and/or the light source is an infrared (IR) and/or visible and/or ultraviolet light source, and/or color filters or polarization filters are attached to the light source and/or to the event camera, and/or the assembly is configured to carry out multispectral sensing.

In a further embodiment of the assembly according to the invention, the light source is shaped in such a way that based on events generated by the event camera capturing the light source during optical transmitting of the line code representation distance and orientation of the light source with respect to the event camera may be estimated.

According to a further aspect of the present invention there is provided a computer program product comprising program code, wherein the computer program product is configured to receive as input events generated by an event camera capturing a light source optically transmitting a line code representation, and which program code when executed on a computing device causes the computing device to carry out the following: determining a recovered binary data sequence based on the received events, wherein the determining of the recovered binary data sequence comprises recovering a clock based on the received events and measuring at least one time difference between received events using the recovered clock.

### BRIEF DESCRIPTION OF DRAWINGS

Exemplar embodiments of the invention are disclosed in the description and illustrated by the drawings in which:

FIG. 1 illustrates schematically the functioning of an event camera observing a flashing light-emitting diode (LED);

FIG. 2 illustrates schematically an assembly according to the invention;

FIGS. 3 to 7 illustrate schematically different embodiments of an assembly according to the invention; and

FIG. 8 illustrates schematically a method according to the invention.

### DETAILED DESCRIPTION OF DRAWINGS

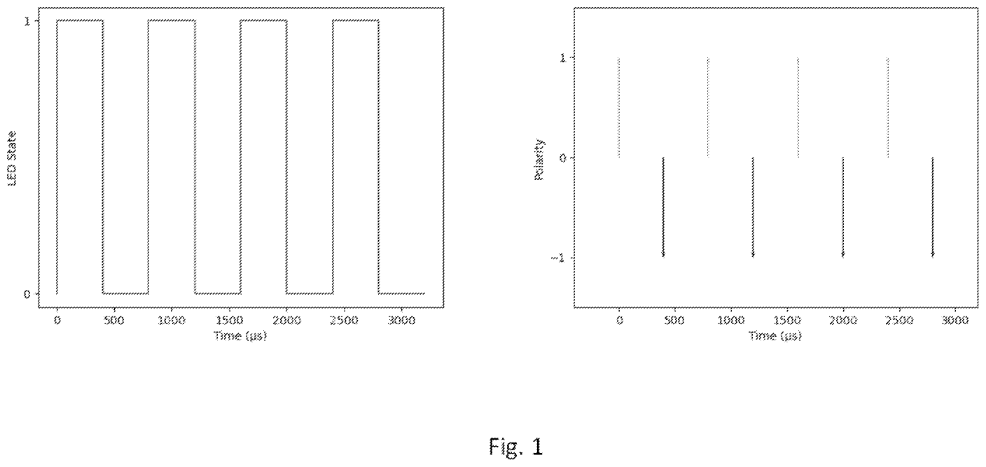

FIG. 1 schematically illustrates the functioning of an event camera observing a flashing light-emitting diode (LED). In the shown example, the LED is periodically turned on and off. The event camera in this embodiment is configured to generate events having polarity: an increasing intensity emitted by the LED and captured by the event camera corresponds to an event with polarity ‘1’, while a decreasing intensity emitted by the LED and captured by the event camera corresponds to an event with polarity ‘−1’. In general, a flashing LED sends out light into many directions: a plurality of pixels of the event camera may therefore independently generate events, and each generated event may be tagged with an identifier describing the pixel which created it, with a time at which it was created and with a polarity.

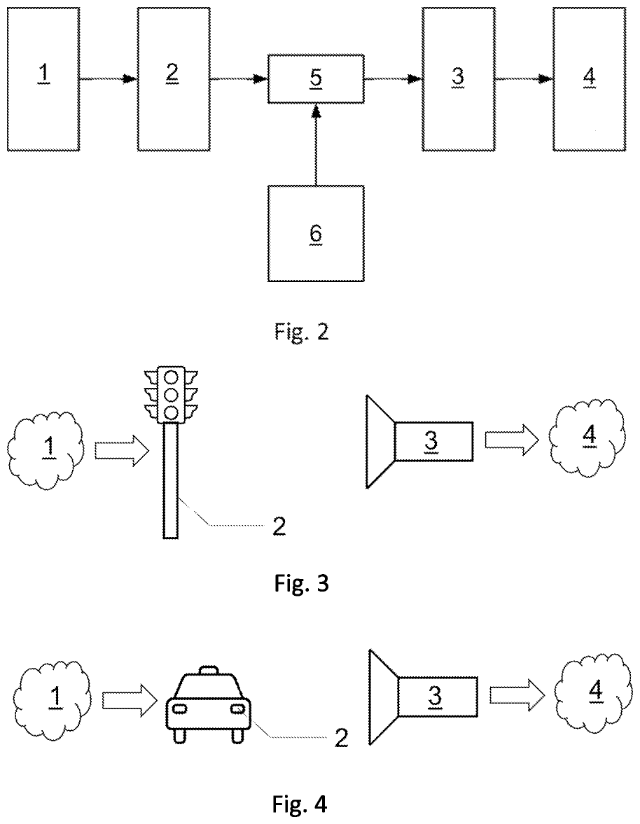

FIG. 2 schematically illustrates an assembly according to the invention. In FIG. 2, an information source 1, a light source 2, an event camera 3 and an information destination 4 are shown. The light source 2 is configured to transmit a line code representation to the event camera 3. The light source 2 transmits over a physical channel 5 which is subject to noise 6. Noise 6 as presently understood may refer to light emitted by other light sources which impinges on photosensitive areas of the event camera 3. Noise may, however, also arise in the event camera itself. The light source 2 is controlled by the information source 1 which instructs the light source 2 to transmit a line code representation corresponding to a binary data sequence.

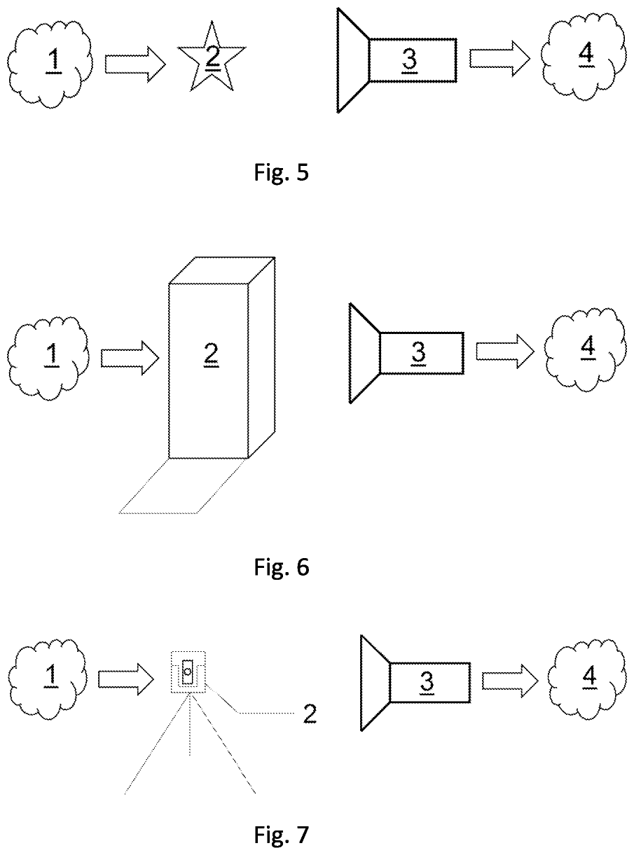

FIGS. 3 to 7 illustrate schematically different embodiments of an assembly according to the invention. FIG. 3 depicts an embodiment in which an information source 1 controls a traffic light 2. The information source 1 may be separate from the traffic light 2 or may be part of the traffic light 2. An event camera 3 is configured to observe the flashing traffic light 2 and provide events to an information destination 4. FIG. 4 shows another embodiment in which the light source 2 is embodied as a car light 2. The information source 1 may again be part of a car which comprises the car light 2, or the information source 1 may be separate from the car. The event camera 3 may be part of another car, or the event camera 3 may be mounted on a different object in the environment through which the car drives. FIG. 5 shows another embodiment in which the light source 2 is embodied as an active marker 2 which is configured to flash based on input provided by the information source 1. FIG. 6 shows another embodiment in which the light source 2 is part of a docking station 2. The docking station 2 may emit light flashes to support a robot, for example, during docking. FIG. 7 shows a total station 2 which is configured to emit light for surveying am environment. Light flashes emitted by the total station 2 may be observed by an event camera 3.

The information source may therefore be embodied as one of: 1) a traffic light control unit controlling operation of a traffic light (corresponding to the light source), or 2) a car lighting control unit controlling operation of a car light (corresponding to the light source), or 3) an active marker control unit for robot tracking, with the active marker corresponding to the light source and emitting the line code representation, or 4) a docking station control unit for space application and/or logistics applications and/or robotics applications, with the docking station comprising the light source, or 5) an aircraft and/or drone landing control unit connected to an airborne or ground light source, or 6) a calibration system for surveying, in particular using a total station, or 7) wearable or portable devices attached to humans or animals.

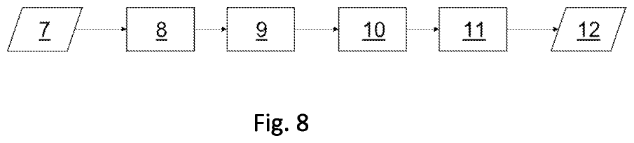

FIG. 8 schematically illustrates a method according to the invention. The method commences operation with a binary data sequence 7. In a first step, a line code representation is determined 8 based on the binary data sequence 7. In a second step, the line code representation is optically transmitted 9 using a light source. In a third step, the optically transmitted line code representation is captured 10 using an event camera, which event camera generates events. In a fourth step, based on the generated events a recovered binary data sequence 12 is determined 11.

1. Method for transmitting a binary data sequence comprising at least two binary values from an information source to an information destination, the method comprising the following steps:
1) determining a line code representation based on the binary data sequence, wherein the line code representation is such that a clock used for determining the line code representation based on the binary data sequence is recoverable from the line code representation,
2) optically transmitting the line code representation using a light source by modulating emitted light intensity of the light source based on the line code representation,
3) capturing the optically transmitted line code representation using an event camera, wherein the event camera is configured to generate events based on intensity changes in the captured optically transmitted line code representation, and
4) determining a recovered binary data sequence based on the generated events, wherein the determining of the recovered binary data sequence comprises recovering the clock based on the generated events and measuring at least one time difference between generated events using the recovered clock, wherein the at least one time difference is used for recovering the binary data sequence.

2. Method according to claim 1, wherein the binary data sequence is modified using an error correction code prior to determining the line code representation based on the binary data sequence.

3. Method according to claim 1, wherein the determined line code representation based on the binary data sequence is a Manchester code representation.

4. Method according to claim 1, wherein the determined line code representation based on the binary data sequence maps at least one group of binary values of the binary data sequence onto a respective at least one group of transmission binary values.

5. Method according to claim 1, wherein a prefix binary data sequence is prepended to the binary data sequence.

6. Method according to claim 1, wherein the line code representation comprises at least one fundamental frequency at which information related to the binary data sequence is transmitted, and wherein the determining of the recovered binary data sequence comprises frequency filtering the generated events to determine events temporally separated from one another at at least one fundamental period corresponding to the at least one fundamental frequency.

7. Method according to claim 1, wherein the binary data sequence is an identifier sequence encoding identity information about the information source.

8. Method according to claim 1, wherein a second binary data sequence is transmitted from the information source to the information destination at least partly in parallel to the transmitting of the binary data sequence.

9. Method according to claim 8, wherein a second line code representation based on the binary data sequence is determined, wherein the second line code representation is such that a second clock used for determining the second line code representation based on the second binary data sequence is recoverable from the second line code representation, and wherein the second line code representation is optically transmitted using the light source or using a second light source, and wherein the optically transmitted second line code representation is captured by the event camera.

10. Method according to claim 8, wherein the second line code representation comprises at least one second fundamental frequency which at least partly differs from the at least one fundamental frequency.

11. Assembly comprising an information source, a light source, an event camera and an information destination, wherein the assembly is configured to carry out the method according to claim 1.

12. Assembly according to claim 11, wherein the information destination is embodied as a computing device, in particular as a microprocessor, and wherein the information source is embodied as one of: 1) a traffic light control unit, or 2) a car lighting control unit, or 3) an active marker control unit for robot tracking, or 4) a docking station control unit for space application and/or logistics applications and/or robotics applications, or 5) an aircraft and/or drone landing control unit, or 6) a calibration system for surveying, in particular using a total station, or 7) wearable or portable devices attached to humans or animals.

13. Assembly according to claim 11, wherein the light source is embodied as a light-emitting diode (LED), and/or wherein the light source is an infrared and/or visible and/or ultraviolet light source, and/or wherein color filters or polarization filters are attached to the light source and/or to the event camera, and/or wherein the assembly is configured to carry out multispectral sensing.

14. Assembly according to claim 11, wherein the light source is shaped in such a way that based on events generated by the event camera capturing the light source during optical transmitting of the line code representation distance and orientation of the light source with respect to the event camera may be estimated.

15. Computer program product comprising program code, wherein the computer program product is configured to receive as input events generated by an event camera capturing a light source optically transmitting a line code representation, and which program code when executed on a computing device causes the computing device to carry out the following: determining a recovered binary data sequence based on the received events, wherein the determining of the recovered binary data sequence comprises recovering a clock based on the received events and measuring at least one time difference between received events using the recovered clock, wherein the at least one time difference is used for recovering the binary data sequence.
